(19) United States
(12) Patent Application Publication
(10) Pub. No.: US 2026/0126684 A1
(43) Pub. Date: May 7, 2026

(54) DISPLAY DEVICE

(71) Applicant: Sharp Display Technology Corporation, Kameyama City (JP)

(72) Inventors: Hiroshi MATSUKIZONO, Kameyama City (JP); Kohhei TANAKA, Kameyama City (JP); Kaoru YAMAMOTO, Kameyama City (JP)

(21) Appl. No.: 19/380,098

(22) Filed: Nov. 5, 2025

(30) Foreign Application Priority Data
Nov. 7, 2024 (JP) 2024-195108

(51) Int. Cl. G02F 1/1333; G02F 1/1362

(52) U.S. Cl. CPC G02F 1/133345; G02F 1/136286

(57) ABSTRACT

A display device includes a first substrate having a display area, a first insulating film placed on top of the first substrate, a first conductive portion that is composed of part of a first conducting film placed on top of the first insulating film, a second insulating film placed on top of the first conducting film, a heating wire that is composed of a second conducting film placed on top of the second insulating film and that overlaps at least part of the first conductive portion, a third insulating film placed on top of the second conducting film, and a second conductive portion that is composed of part of a third conducting film placed on top of the third insulating film and that overlaps at least part of the heating wire. The second and third insulating films are greater in film thickness than the first insulating film.

### BACKGROUND

### 1. Field

The present disclosure relates to a display device that brings about improvement in yield.

### 2. Description of the Related Art

Conventionally, as an example of a display device, a liquid crystal display device disclosed in U.S. Patent Application Publication No. 2019/0353940 has been known. The liquid crystal display device disclosed in U.S. Patent Application Publication No. 2019/0353940 includes a first substrate, a second substrate placed opposite the first substrate, a liquid crystal layer sandwiched between the first substrate and the second substrate, and a heating electrode placed at a side of the first substrate that faces the liquid crystal layer.

In the liquid crystal display device disclosed in U.S. Patent Application Publication No. 2019/0353940, the heating electrode intersects a data wire located at a higher layer than the heating electrode. The heating electrode and the data wire are kept insulated from each other by an interlayer insulating layer being sandwiched therebetween. However, the interlayer insulating layer is about equal in film thickness to a gate insulating layer located at a lower layer than the heating electrode and about equal in film thickness to a foundation layer located at a lower layer than the gate insulating layer. For this reason, in a case where there occurs a defect in the interlayer insulating layer or in a case where foreign matter possessing electrical conductivity is mixed into the interlayer insulating layer, the heating electrode may become short-circuited with the data wire that the heating electrode intersects. As a result of that, there is concern that there may be deterioration in yield.

It is desirable to bring about improvement in yield.

### SUMMARY

According to an aspect of the disclosure, there is provided a display device including a first substrate having a display area where an image is displayed, a first insulating film placed on top of the first substrate, a first conductive portion that is composed of part of a first conducting film placed on top of the first insulating film and that is placed in the display area, a second insulating film placed on top of the first conducting film, a heating wire that is composed of a second conducting film placed on top of the second insulating film and that overlaps at least part of the first conductive portion in the display area, a third insulating film placed on top of the second conducting film, and a second conductive portion that is composed of part of a third conducting film placed on top of the third insulating film and that overlaps at least part of the heating wire in the display area. The second insulating film and the third insulating film are greater in film thickness than the first insulating film.

### BRIEF DESCRIPTION OF THE DRAWINGS

FIG. 1 is a plan view of a liquid crystal panel, a flexible substrate, a control substrate, or other components of a liquid crystal display device according to Embodiment 1;

FIG. 2 is a cross-sectional view of the liquid crystal panel, the flexible substrate, the control substrate, or other components according to Embodiment 1;

FIG. 3 is a circuit diagram showing an electrical configuration of an array substrate constituting the liquid crystal panel according to Embodiment 1;

FIG. 4 is a cross-sectional view showing a configuration of a TFT of the array substrate according to Embodiment 1 and an area therearound;

FIG. 5 is a plan view showing a configuration pertaining to a heater function of the array substrate according to Embodiment 1;

FIG. 6 is a cross-sectional view showing a configuration of a central part of a pixel electrode of the array substrate according to Embodiment 1 in a Y-axis direction and an area therearound;

FIG. 7 is a cross-sectional view showing a configuration of a TFT of an array substrate according to Embodiment 2 and an area therearound; and

FIG. 8 is a cross-sectional view showing a configuration of a central part of a pixel electrode of the array substrate according to Embodiment 2 in a Y-axis direction and an area therearound.

### DESCRIPTION OF THE EMBODIMENTS

### Embodiment 1

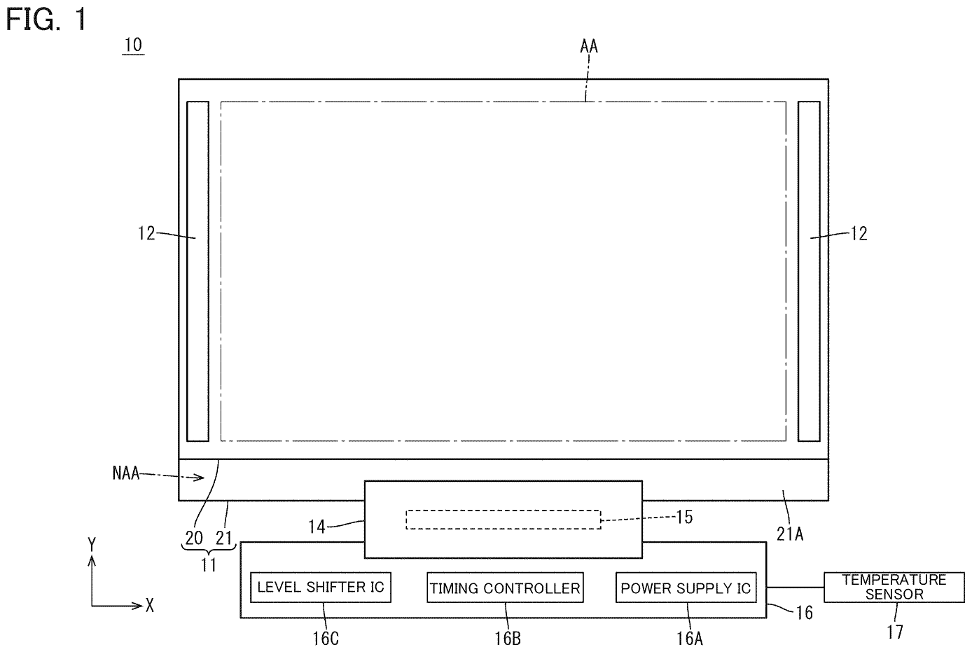

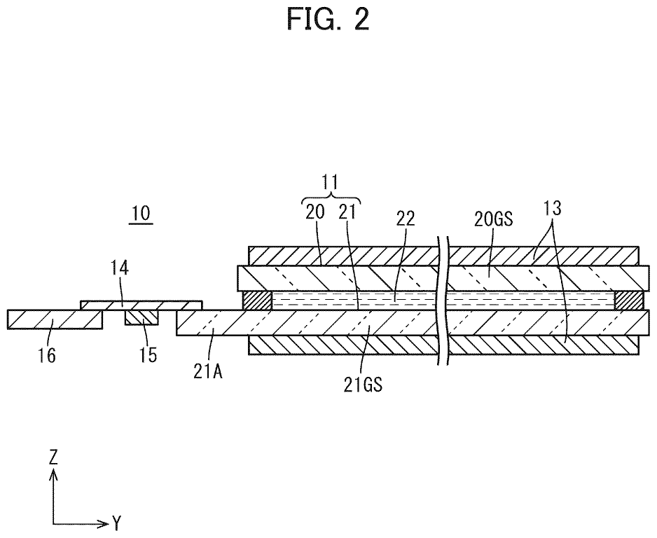

Embodiment 1 is described with reference to FIGS. 1 to 6. The present embodiment illustrates a liquid crystal display device 10 that is used in an on-board CMS (camera monitor system). The on-board CMS is a system that, as a replacement for a side mirror or a rearview mirror using a mirror-finished surface in an automobile, displays, on a display (liquid crystal display device 10), an image taken by a camera. Note that some of the drawings show an X axis, a Y axis, and a Z axis and are drawn so that the direction of each axis is an identical direction in each drawing. Further, FIGS. 2, 5, and 6 show front side up and back side down.

As shown in FIG. 1, the liquid crystal display device 10 includes at least a liquid crystal panel (display device, display panel) 11 that has a horizontally long rectangular shape and that is capable of displaying an image and a backlight device (lighting device) serving as an external light source that illuminates the liquid crystal panel 11 with light for use in display. The backlight device is placed at the back (behind) the liquid crystal panel 11 and includes a light source (e.g. an LED) that emits white light, an optical member that, by imparting an optical effect to light from the light source, converts the light into surface light, or other components. A central portion of a screen (principal surface) of the liquid crystal panel 11 serves as a display area AA where an image is displayed. On the other hand, a frame-shaped outer peripheral portion of the screen of the liquid crystal panel 11 that surrounds the display area AA serves as a non-display area NAA where the image is not displayed.

In the non-display area NAA of the liquid crystal panel 11, as shown in FIG. 1, a circuit unit (peripheral circuit unit, gate circuit unit) 12 is provided. A pair of the circuit units 12 are placed in such a manner that the display area AA is interposed therebetween in an X-axis direction. The circuit unit 12 is provided in a band-like area extending along a Y-axis direction. The circuit unit 12 is intended to supply a scanning signal to the after-mentioned gate wire 26 and is provided monolithically in the after-mentioned array substrate 21. The circuit unit 12 is a GDM (gate driver monolithic) circuit. The circuit unit 12 includes a shift register circuit that outputs a scanning signal at a predetermined timing, a buffer circuit for amplifying a scanning signal, or other circuits.

The liquid crystal panel 11 is described in detail with reference to FIG. 2 in addition to FIG. 1. As shown in FIGS. 1 and 2, the liquid crystal panel 11 includes a pair of substrates 20 and 21 bonded together. A front (frontward) one of the pair of substrates 20 and 21 is a counter substrate (second substrate) 20, and a back (backward) one of the pair of substrates 20 and 21 is an array substrate (first substrate) 21. The counter substrate 20 is obtained by forming a stack of various types of film on an inner surface of a glass substrate (substrate unit) 20GS, and the array substrate 21 is obtained by forming a stack of various types of film on an inner surface of a glass substrate (substrate unit) 21GS. Sandwiched between the pair of substrates 20 and 21 is a liquid crystal layer (medium layer) 22 containing liquid crystal molecules constituting a substance whose optical properties vary in the presence of the application of an electric field. Sandwiched between the outer edges of the pair of substrates 20 and 21 is a seal portion 23 that seals in the liquid crystal layer 22. The seal portion 23 is formed in a rectangular frame shape (endless annular shape) to surround the liquid crystal layer 22. Attached to outer surfaces of the two substrates 20 are polarizing plates 13, respectively.

As shown in FIGS. 1 and 2, the counter substrate 20 has short-side dimensions that are shorter than those of the array substrate 21. The counter substrate 20 is bonded to the array substrate 21 in such a manner that one end of the counter substrate 20 meets one end of the array substrate 21 in a short-side direction (Y-axis direction). Accordingly, the other end of the array substrate 21 in the short-side direction serves as a first end portion 21A exposed by projecting laterally from the counter substrate 20. The first end portion 21A is one side portion of the non-display area NAA, which has a frame shape, that extends along the X-axis direction, and is mounted with a flexible substrate 14 for supplying various types of signal. Further, one end of the array substrate 21 in the short-side direction serves as a second end portion 21B. The second end portion 21B is one side portion of the non-display area NAA, which has a frame shape, that extends along the X-axis direction, and has such a relationship with the first end portion 21A that the display area AA is interposed between the first end portion 21A and the second end portion 21B in the Y-axis direction.

The flexible substrate 14 is configured such that a large number of wiring patterns are formed on a base material composed of a synthetic resin material (such as polyimide resin) having insulating properties and flexibility. As shown in FIGS. 1 and 2, a driver 15 is mounted on the flexible substrate 14 by COF (Chip on Film). The driver 15 is composed of an LSI chip having a drive circuit inside. The driver 15 processes various types of signal that are transmitted by the flexible substrate 14. The driver 15 is intended to supply various types of signal (e.g. an image signal) to a wire (e.g. the after-mentioned source wire 27) of the display area AA. One end of the flexible substrate 14 is connected to the first end portion 21A of the array substrate 21, and the other end of the flexible substrate 14 is connected to a control substrate 16. The flexible substrate 14 is connected to a central portion of the first end portion 21A in the X-axis direction. The control substrate 16 is configured such that a plurality of circuit components are mounted on a rigid substrate made of synthetic resin (e.g. made of paper phenol or made of glass epoxy). The plurality of circuit components include a power supply IC (integrated circuit) (feeder) 16A serving as a direct-current power supply for outputting electric power, a timing controller 16B that generates various types of signal to be supplied to the driver 15, a level shifter IC 16C for controlling (stepping down and stepping up) a voltage level, or other components. The control substrate 16 has a connector area to which the flexible substrate 14 or other components are connected. The control substrate 16 is disposed to overlap the back of the backlight device by the flexible substrate 14 being bent in a turnover shape. Connected to the control substrate 16 is a temperature sensor 17. The temperature sensor 17 is placed in such a position as to be close to or in contact with the liquid crystal panel 11, and is enabled to detect the temperature of an area around the liquid crystal panel 11.

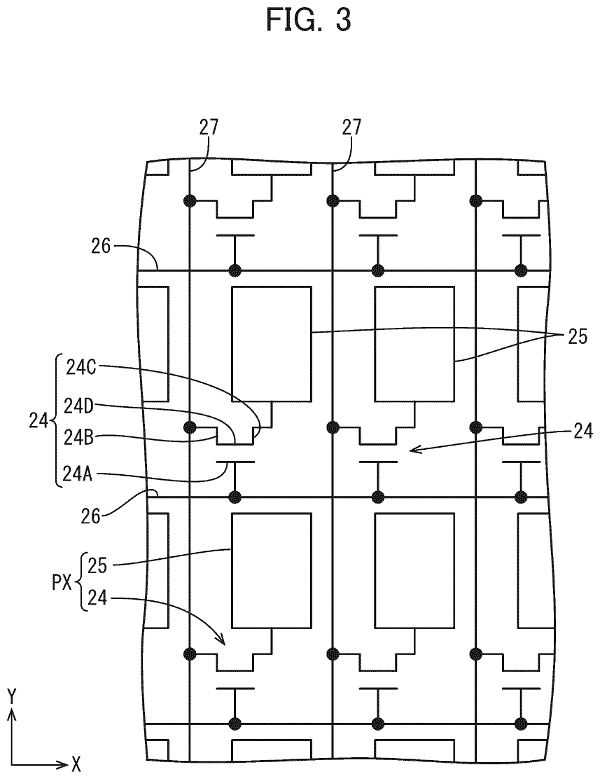

Next, a configuration of the array substrate 21 in the display area AA is described with reference to FIG. 3. As shown in FIG. 3, at least a TFT (switching element, transistor) 24 and a pixel electrode 25 are provided at the side of an inner surface of the array substrate 21 in the display area AA. The TFT 24 and the pixel electrode 25 constitute a pixel PX serving as a display unit together with the after-mentioned color filter. A plurality of the TFTs 24 and a plurality of the pixel electrodes 25 are provided in a matrix (rows and columns) by being arranged at spacings along the X-axis direction and the Y-axis direction. Arranged around this TFT 24 and this pixel electrode 25 are a gate wire (scanning wire) 26 and a source wire (first conductive portion, image wire, signal wire) 27 that are orthogonal to (intersect) each other. The gate wire 26 extends along the X-axis direction, and includes a plurality of the gate wires 26 placed at spacings in the Y-axis direction. The source wire 27 extends along the Y-axis direction (first direction), and includes a plurality of the source wires 27 placed at spacings in the X-axis direction (second direction intersecting the first direction). The TFT 24 includes a gate electrode 24A connected to the gate wire 26, a source electrode 24B connected to the source wire 27, a drain electrode 24C connected to the pixel electrode 25, and a semiconductor component 24D connected to the source electrode 24B and the drain electrode 24C. Moreover, the TFT 24 is driven in accordance with a scanning signal supplied from the circuit unit 12 to the gate electrode 24A through the gate wire 26. Then, a potential pertaining to an image signal supplied from the driver 15 to the source electrode 24B through the source wire 27 is supplied to the drain electrode 24C via the semiconductor component 24D. As a result of that, the pixel electrode 25 is charged to the potential pertaining to the image signal. The pixel electrode 25 is placed in an area surrounded by the gate wire 26 and the source wire 27, and is substantially rectangular in planar shape.

Further, a plurality of color filters are provided in such a position on the counter substrate 20 in the display area AA as to be opposite to each pixel electrode 25 of the array substrate 21. The color filters are placed such that three colors of R (red), green (G), and B (blue) are repeatedly arranged in a predetermined order, and constitute pixels PX (red, green, and blue pixels) of each separate color together with the TFT 24 and the pixel electrode 25. The three pixels PX, namely the red, green, and blue pixels, constitute a display pixel that is capable of a color display of a predetermined tone. Further, a light shield (black matrix) for avoiding a mixture of colors is formed between one color filter and another. Provided on the innermost surfaces of the counter substrate 20 and the array substrate 21 are alignment films for aligning the liquid crystal molecules contained in the liquid crystal layer 22, respectively.

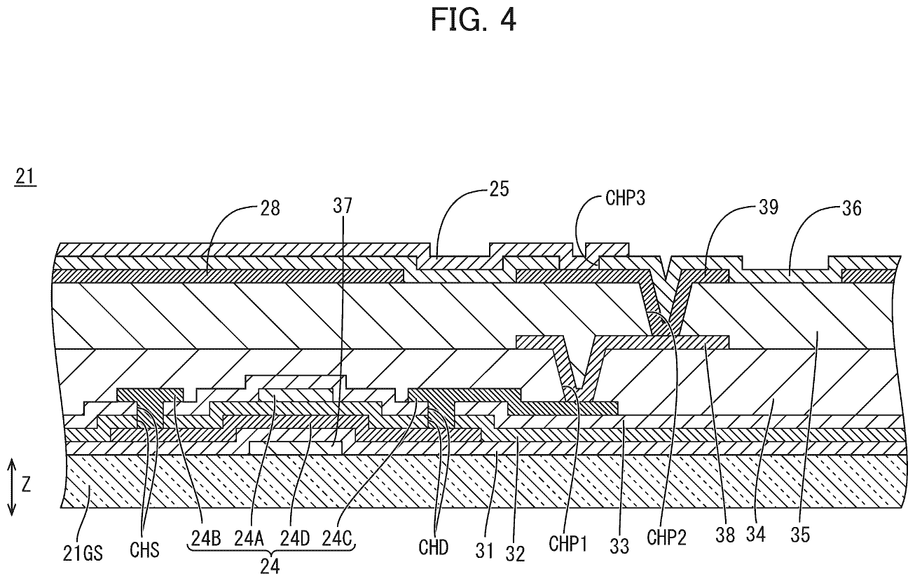

Various types of film stacked at the side of the inner surface of the array substrate 21 are described here with reference to FIG. 4. FIG. 4 is a cross-sectional view showing a configuration of a TFT 24 of the array substrate 21 and an area therearound. On the glass substrate (substrate) 21GS of the array substrate 21, as shown in FIG. 4, at least a first metal film, a basecoat film 31, a semiconductor film, a gate insulating film 32, a second metal film, a first interlayer insulating film (first insulating film) 33, a third metal film (first conducting film), a first planarizing film (second insulating film) 34, a fourth metal film (second conducting film), a second planarizing film (third insulating film) 35, a first transparent electrode film (third conducting film), a second interlayer insulating film (fourth insulating film) 36, a second transparent electrode film (fourth conducting film), an alignment film (not illustrated) are stacked in this order from a lower layer side (glass substrate 21GS side).

The first metal film, the second metal film, the third metal film, and the fourth metal film each have electric conductivity by being a single-layer film composed of one type of metal material or a laminated film or alloy composed of different types of metal material. The first metal film constitutes the after-mentioned light shield 37. The second metal film constitutes the gate wire 26, the gate electrode 24A of the TFT 24, or other components. The third metal film constitutes the source wire 27, the source electrode 24B and drain electrode 24C of the TFT 24, or other components. The fourth metal film constitutes the after-mentioned first intermediate electrode 38 or other components. The fourth metal film is, for example, a laminated film and may include, at the uppermost layer, a layer composed of Ti (titanium) or Mo (molybdenum). The semiconductor film is composed of a polysilicon semiconductor material (semiconductor material) having a crystalline substance prepared by a publicly-known method such as laser crystallization. The polysilicon semiconductor material of the semiconductor film is high in electron mobility than an amorphous silicon semiconductor material and an oxide semiconductor material. The semiconductor film constitutes the semiconductor component 24D of the TFT 24 or other components. The first transparent electrode film and the second transparent electrode film are made of a transparent electrode material (e.g. ITO (indium tin oxide) or IZO (indium zinc oxide)). The first transparent electrode film constitutes the common electrode (second conductive portion) 28 or other components. The second transparent electrode film constitutes the pixel electrode 25 or other components.

The basecoat film 31, the gate insulating film 32, the first interlayer insulating film 33, and the second interlayer insulating film 36 are each composed of SiO₂ (oxide silicon, Si oxide), SiNₓ (silicon nitride), or other inorganic materials (inorganic resin material). The first planarizing film 34 and the second planarizing film 35 are composed of an organic material such as PMMA (acrylic resin). The film thicknesses of the first planarizing film 34 and the second planarizing film 35 are usually greater than the film thicknesses of the basecoat film 31, the gate insulating film 32, the first interlayer insulating film 33, and the second interlayer insulating film 36. Specifically, while the film thicknesses of the basecoat film 31, the gate insulating film 32, the first interlayer insulating film 33, and the second interlayer insulating film 36, which are composed of an inorganic material, are, for example, approximately several tens of millimeters to several hundreds of millimeters, the film thicknesses of the first planarizing film 34 and the second planarizing film 35, which are composed of an organic material, are, for example, approximately 1 μm to 3 μm. An inner surface of the array substrate 21 (that faces the liquid crystal layer 22) is planarized by the first planarizing film 34 and the second planarizing film 35. The basecoat layer 31 is sandwiched between the first metal film and the semiconductor film. The gate insulating film 32 is sandwiched between the semiconductor film and the second metal film. The first interlayer insulating film 33 is sandwiched between the second metal film and the third metal film. The first planarizing film 34 is sandwiched between the third metal film and the fourth metal film. The second planarizing film 35 is sandwiched between the fourth metal film and the first transparent electrode film. The second interlayer insulating film 36 is sandwiched between the first transparent electrode film and the second transparent electrode film.

A cross-sectional configuration of the TFT 24 is described. As shown in FIG. 4, the TFT 24 according to the present embodiment is of a so-called top-gate type in which the gate electrode 24A, which is composed of part of the second metal film, is disposed at a higher layer than the semiconductor component 24D, which is composed of part of the semiconductor film, to overlap the semiconductor component 24D via the gate insulating film 32. While both end portions of the semiconductor component 24D that do not overlap the gate electrode 24A are resistance-decreased regions made low in resistance, a central portion of the semiconductor component 24D that overlaps the gate electrode 24A is a non-resistance-decreased region that is not made low in resistance. The resistance-decreased regions of the semiconductor component 24D are formed by performing a resistance-decreasing process with the gate electrode 24A as a mask, for example, in the process of manufacturing the array substrate 21. The array substrate 21 is provided with a light shield 37 that overlaps at least the non-resistance-decreased region of the semiconductor component 24D. The light shield 37 is composed of part of the first metal film. The light shield 37, which is placed at a lower layer than the non-resistance-decreased region of the semiconductor component 24D, can block light that is shone on the non-resistance-decreased region of the semiconductor component 24D from the backlight device. This makes it possible to reduce fluctuations in the characteristics of the TFT 24 that can occur in a case where the non-resistance-decreased region of the semiconductor component 24D is irradiated with light.

As shown in FIG. 4, the source electrode 24B of the TFT 24 is composed of part of the third metal film, and is disposed to overlap one resistance-decreased region (one end portion) of the semiconductor component 24D via the gate insulating film 32 and the first interlayer insulating film 33. The gate insulating film 32 and the first interlayer insulating film 33 have a source contact hole (first contact hole) CHS bored through portions of the gate insulating film 32 and the first interlayer insulating film 33 that overlap both the source electrode 24B and the semiconductor component 24D. The source electrode 24B and the semiconductor component 24D are connected to each other through the source contact hole CHS. The drain electrode 24C of the TFT 24 is composed of part of the third metal film, and is disposed to overlap the other resistance-decreased region (other end portion) of the semiconductor component 24D via the gate insulating film 32 and the first interlayer insulating film 33. The gate insulating film 32 and the first interlayer insulating film 33 have a drain contact hole (second contact hole) CHD bored through portions of the gate insulating film 32 and the first interlayer insulating film 33 that overlap both the drain electrode 24C and the semiconductor component 24D. The drain electrode 24C and the semiconductor component 24D are connected to each other through the drain contact hole CHD.

As shown in FIG. 4, the TFT 24 includes a first intermediate electrode (first connected portion) 38 and a second intermediate electrode (second connected portion) 39 that are located in between the drain electrode 24C, which is composed of part of the third metal film, and the pixel electrode 25, which is composed of part of the second transparent electrode film. The first intermediate electrode 38 is composed of part of the fourth metal film (i.e. a portion of the fourth metal film that is different from the touch wires 30 and a heating wire 40). The first intermediate electrode 38 is disposed at a higher layer than part of the drain electrode 24C (i.e. a portion of the drain electrode 24C that does not overlap the semiconductor component 24D) to overlap the part of the drain electrode 24C via the first planarizing film 34. The second intermediate electrode 39 is composed of part of the first transparent electrode film (i.e. a portion of the first transparent electrode film that is different from the common electrode 28). The second intermediate electrode 39 is disposed at a higher layer than part of the first intermediate electrode 38 (i.e. a portion of the first intermediate electrode 28 that does not overlap the drain electrode 24C) to overlap the part of the first intermediate electrode 38 via the second planarizing film 35. The second intermediate electrode 39 is placed at a lower layer than part of the pixel electrode 25 to overlap the part of the pixel electrode 25 via the second interlayer insulating film 36. The first planarizing film 34, which is sandwiched between the drain electrode 24C and the first intermediate electrode 38, has a first pixel contact hole (third contact hole) CHP1 bored in a portion of the first planarizing film 34 that overlaps both the drain electrode 24C and the first intermediate electrode 38. The drain electrode 24C and the first intermediate electrode 38 are connected to each other through the first pixel contact hole CHP1 of the first planarizing film 34. The second planarizing film 35, which is sandwiched between the first intermediate electrode 38 and the second intermediate electrode 39, has a second pixel contact hole (fourth contact hole) CHP2 bored in a portion of the second planarizing film 35 that overlaps both first intermediate electrode 38 and the second intermediate electrode 39. The first intermediate electrode 38 and the second intermediate electrode 39 are connected to each other through the second pixel contact hole CHP2 of the second planarizing film 35. The second interlayer insulating film 36, which is sandwiched between the second intermediate electrode 39 and the pixel electrode 25, has a third pixel contact hole (fifth contact hole) CHP3 bored in a portion of the second interlayer insulating film 36 that overlaps both the second intermediate electrode 39 and the pixel electrode 25. The second intermediate electrode 39 and the pixel electrode 25 are connected to each other through the third pixel contact hole CHP3 of the second interlayer insulating film 36. In this way, the drain electrode 24C is connected to the pixel electrode 25 via the first intermediate electrode 38 and the second intermediate electrode 39.

Further, as shown in FIG. 4, the common electrode 28 of the array substrate 21 in the display area AA is disposed to overlap all pixel electrodes 25. The common electrode 28 extends substantially all over the display area AA. The common electrode 28, which is composed of part of the first transparent electrode film, is placed at a lower layer (i.e. closer to the glass substrate 21GS) than the pixel electrode 25, which is composed of part of the second transparent electrode film, with a distance equal to the film thickness of the second interlayer insulating film 36 between the common electrode 28 and the pixel electrode 25. The common electrode 28 is supplied with a common potential signal that is at a common electrode (reference potential). The pixel electrode 25, which is located at a higher layer than the common electrode 28, has a slit 25A bored therein. When driving of the TFT 24 causes the pixel electrode 25 to be charged to a potential based on an image signal transmitted to the source wire 27, a potential difference is generated between the pixel electrode 25 and the common electrode 28. Then, a fringe field (oblique field) containing a component normal to a principal surface of the array substrate 21 in addition to a component parallel to the principal surface of the array substrate 21 is generated between an opening edge of the slit 25A and the common electrode 28. Accordingly, this fringe field can be utilized to control a state of alignment of the liquid crystal molecules contained in the liquid crystal layer 22, and a predetermined display is done on the basis of this state of alignment of the liquid crystal molecules. That is, the liquid crystal panel 11 according to the present embodiment operates in an FFS mode (fringe field switching) mode.

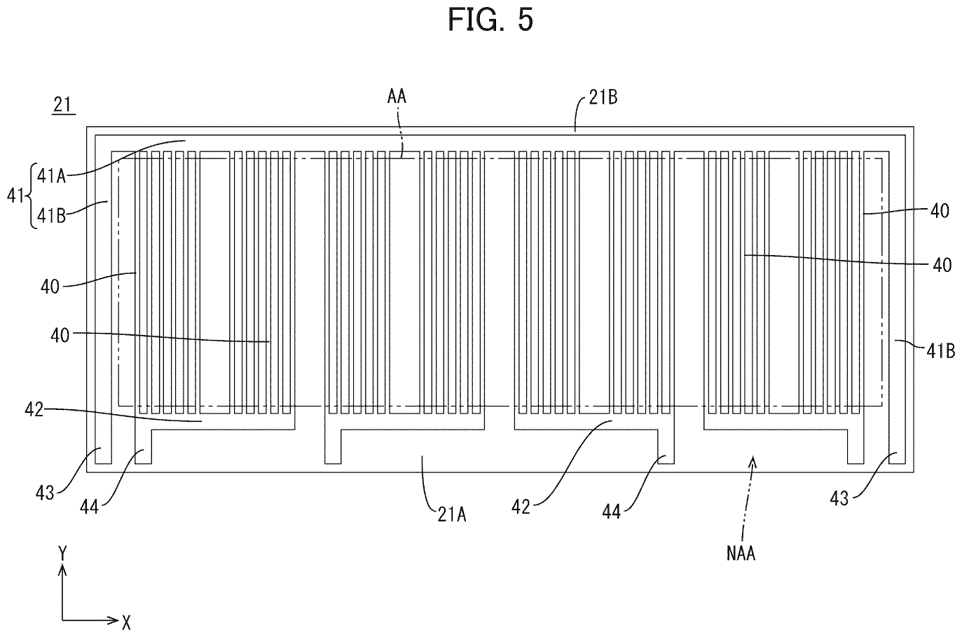

Incidentally, since the liquid crystal display device 10 according to the present disclosure is used in an on-board CMS, there tends to be strong concern that there may be a decrease in the response speed of the liquid crystal panel 11 due to an increase in the viscosity of the liquid crystal layer 22 in a cool environment. To address this problem, the liquid crystal panel 11 according to the present embodiment has a heater function for improving the response speed at low temperature, and has an in-cell configuration for fulfilling the heater function. The configuration pertaining to the heater function is described with reference to FIG. 5 or other drawings.

As shown in FIG. 5, the array substrate 21 includes, as the configuration pertaining to the heater function, a heating wire 40, a first trunk wire 41, a second trunk wire 42, and a first heating terminal area 43, and a second heating terminal area 44. The heating wire 40 is placed in the display area AA, extends along the Y-axis direction, and runs parallel to the source wire 27. The heating wire 40 longitudinally traverses the display area AA, and extends from the first portion 21A to the second end portion 21B of the array substrate 21 in the Y-axis direction. A plurality of the heating wires 40 are placed at spacings in the X-axis direction.

As shown in FIG. 5, the first trunk wire 41 and the second trunk wire 42 are both placed in the non-display area NAA. Specifically, the first trunk wire 41 extends along three sides (including the second end portion 21B) of the non-display area NAA, which has a frame shape, except the first end portion 21A, and surrounds the display area AA on three sides. The first trunk wire 41 has a first trunk wire constituting portion 41A placed in the second end portion 21B of the non-display area NAA and a pair of second trunk wire constituting portions 41B placed on a pair of sides of the non-display area NAA located at both ends of the non-display area NAA in the X-axis direction. The first trunk wire constituting portion 41A extends along the X-axis direction, and is adjacent to the entire length of a side (upper side of FIG. 5) of the display area AA, which has a rectangular shape, that faces the second end portion 21B in the Y-axis direction. The first trunk wire constituting portion 41A is joined to first ends (on the upper side of FIG. 5; on the side that faces the second end portion 21B) of all heating wires 40, which are placed in the display area AA, in the Y-axis direction. The pair of second trunk wire constituting portions 41B extend along the Y-axis direction, and are adjacent to the entire lengths of both sides of the display area AA, which has a rectangular shape, that extend along the Y-axis direction, respectively. Ends of the second trunk wire constituting portions 41B that face the first end portion 21A are connected to the after-mentioned first heating terminal area 43.

As shown in FIG. 5, the second trunk wire 42 is placed in the first end portion 21A of the non-display area NAA, which has a frame shape. The second trunk wire 42 extends along the X-axis direction in the first end portion 21A, and includes a plurality of the second trunk wires 42 placed at spacings in the X-axis direction. The plurality of second trunk wires 42 are placed in a linear arrangement. The second trunk wire 42 is joined to second ends (on the lower side of FIG. 5; beside the first end portion 21A) of the plurality of heating wires 40, which are placed in the display area AA, in the Y-axis direction.

As shown in FIG. 5, the first heating terminal area 43 and the second heating terminal area 44 are both provided in the first end portion 21A of the array substrate 21. Specifically, the first heating terminal area 43 and the second heating terminal area 44 are both placed in such positions in the first end portion 21A as to overlap the flexible substrate 14, and are connected via an anisotropic conductive film (ACF) to a plurality of terminal areas of the flexible substrate 14.

As shown in FIG. 5, two first heating terminal areas 43 are placed at a distance from each other in the X-axis direction in the first end portion 21A. The two first heating terminal areas 43 are joined to ends (on the lower side of FIG. 4; beside the first end portion 21A) of the two second trunk wire constituting portions 41B of the first trunk wire 41 that face away from the first trunk wire constituting portion 41A in the Y-axis direction, respectively. The two first heating terminal areas 43 are connected to positive electrode terminal areas included in the terminal areas of the flexible substrate 14 and connected to a positive electrode of the power supply IC (direct-current power supply) 16A, respectively. A plurality of the second heating terminal areas 44 are placed at spacings in the X-axis direction in the first end portion 21A. The number of second heating terminal areas 44 that are provided is equal to the number of second trunk wires 42 that are provided. The plurality of second heating terminal areas 44 are connected separately to each of the plurality of second trunk wires 42. The second heating terminal areas 44 are joined to ends of the second trunk wires 42 at an end of the array substrate 21 in the X-axis direction. The plurality of second heating terminal areas 44 are connected to negative electrode terminal areas included in the terminal areas of the flexible substrate 14 and connected to a negative electrode of the power supply IC 16A, respectively.

As shown in FIG. 1, the array substrate 21 of the liquid crystal panel 11 configured as noted above is supplied with various types of signal (including image signals) for displaying an image and electric power for fulfilling the heater function from the control substrate 16 via the flexible substrate 14. Specifically, the circuit unit 12 of the array substrate 21 is supplied with gate start pulse signals, clock signals, or other signals from the control substrate 16 via the flexible substrate 14. The circuit unit 12 outputs scanning signals to the plurality of gate wires 26 in sequence in accordance with the gate start pulse signals, the clock signals, or other signals thus supplied. The plurality of source wires 27 of the array substrate 21 are supplied with image signals from the driver 15 via the flexible substrate 14. By being driven at timings at which the scanning signals are supplied to the gate wires 26, the TFTs 24 can charge the pixel electrodes 25 to potentials based on the image signals supplied to the source wires 27.

As shown in FIGS. 1 and 5, the positive electrode of the power supply IC 16A of the control substrate 16 is connected to the first heating terminal area 43 of the array substrate 21 via the flexible substrate 14, and the negative electrode of the power supply IC 16A of the control substrate 16 is connected to the second heating terminal area 44 via the flexible substrate 14. As a result of this, based on a potential difference between the first trunk wire 41, which is connected to the first heating terminal area 43, and the second trunk wire 42, which is connected to the second heating terminal area 44, a current flows through a plurality of the heating wires 40 from the first trunk wire 41 toward the second trunk wire 42. As the plurality of heating wires 40 are energized, heat corresponding to the respective wiring resistances of the plurality of heating wires 40 is generated from the plurality of heating wires 40. The heat generated from the plurality of heating wires 40, which are placed in the display area AA, is transferred to the liquid crystal layer 22, whereby the liquid crystal layer 22 is heated in the display area AA. Accordingly, even in a cool environment, the liquid crystal layer 22 is heated by the heat from the plurality of heating wires 40, whereby the viscosity of the liquid crystal layer 22 in the display area AA can be decreased. This makes it possible to improve the response speed of the liquid crystal panel 11 and improve the display quality of an image. The amount of current that is passed through the plurality of heating wires 40 from the power supply IC 16A or other quantities are controlled in accordance with the temperature detected by the temperature sensor 17.

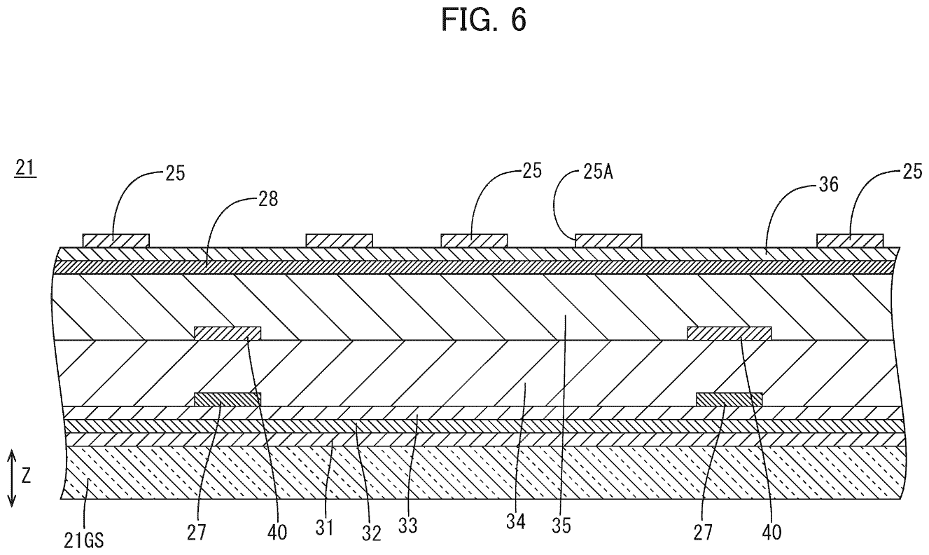

The heating wire 40, the first trunk wire 41, the second trunk wire 42, the first heating terminal area 43, and the second heating terminal area 44, which constitute the configuration pertaining to the heater function, are each composed of part of the fourth metal film. As shown in FIG. 6, the heating wire 40, which is composed of part of the fourth metal film, is disposed to overlap the source wire 27, which is composed of part of the third metal film, in a plan view. At least in the display area AA, the heating wire 40 overlaps the source wire 27 while running parallel to the entire length of the source wire 27. This makes it possible to keep the aperture ratio of each pixel PX high. The first planarizing film 34, which is sandwiched between the heating wire 40 and the source wire 27, is greater in film thickness than other insulating films (including the first interlayer insulating film 33) made from an inorganic material. This makes it highly certain that the heating wire 40 and the source wire 27 are kept insulated from each other. The heating wire 40, which is composed of part of the fourth metal film, is disposed to overlap the common electrode 28, which is composed of part of the first transparent electrode film, in a plan view. The second planarizing film 35, which is sandwiched between the heating wire 40 and the common electrode 28, is greater in film thickness than other insulating films (including the first interlayer insulating film 33) made from an inorganic material. This makes it highly certain that the heating wire 40 and the common electrode 28 are kept insulated from each other. This makes it harder for the heating wire 40 to become short-circuited with the source wire 27 or the common electrode 28 than has conventionally been the case, thus making it possible to bring about improvement in yield.

Further, as shown in FIGS. 4 and 6, the heating wire 40 and the first intermediate electrode 38 are composed of parts of the fourth metal film; therefore, in manufacturing the liquid crystal panel 11, the heating wire 40 can be provided in a step of providing the first intermediate electrode 38 by patterning the fourth metal film. This makes it possible to reduce the number of processes for manufacturing the liquid crystal panel 11.

Further, as shown in FIG. 1, the power supply IC 16A, which supplies electric power to the heating wire 40, has a power density of lower than or equal to 1000 W/mm³ of electric power that is supplied to the heating wire 40. This makes it possible to inhibit the amount of heat generated from the heating wire 40 from becoming excessive. This makes it hard for the first planarizing film 34 and the second planarizing film 35, both of which are made from an organic material, to deteriorate due to excessive heating. It is more preferable that the power supply IC 16A have a power density of lower than or equal to 100 W/mm³ of electric power that is supplied to the heating wire 40. This makes it possible to inhibit the amount of heat generated from the heating wire 40 from becoming excessive. This makes it hard for the first planarizing film 34 and the second planarizing film 35, both of which are made from an organic material, to deteriorate due to excessive heating.

As described above, a liquid crystal panel (display device) 11 according to the present embodiment includes an array substrate (first substrate) 21 having a display area AA where an image is displayed, a first interlayer insulating film (first insulating film) 33 placed on top of the array substrate 21, a source wire 27 serving as a first conductive portion that is composed of part of a third metal film (first conducting film) placed on top of the first interlayer insulating film 33 and that is placed in the display area AA, a first planarizing film (second insulating film) 34 placed on top of the third metal film, a heating wire 40 that is composed of a fourth metal film (second conducting film) placed on top of the first planarizing film 34 and that overlaps at least part of the source wire 27, which is the first conductive portion, in the display area AA, a second planarizing film (third insulating film) 35 placed on top of the fourth metal film, and a common electrode 28 serving as a second conductive portion that is composed of part of a first transparent electrode film (third conducting film) placed on top of the second planarizing film 35 and that overlaps at least part of the heating wire 40 in the display area AA. The first planarizing film 34 and the second planarizing film 35 are greater in film thickness than the first interlayer insulating film 33.

When the heating wire 40 generates heat as it is energized, the display area AA of the array substrate 21 is heated. This makes it possible to improve the responsiveness of the liquid crystal panel 11 even in a case where the outside temperature is low. The heating wire 40 overlaps at least part of the source wire 27, which is the first conductive portion, via the first planarizing film 34 and overlaps at least part of the common electrode 28, which is the second conductive portion, via the second planarizing film 35. Since the first planarizing film 34 is greater in film thickness than the first interlayer insulating film 33, it is highly certain that the heating wire 40 and the source wire 27, which is the first conductive portion, are kept insulated form each other. Since the second planarizing film 35 is greater in film thickness than the first interlayer insulating film 33, it is highly certain that the heating wire 40 and the common electrode 28, which is the second conductive portion, are kept insulated from each other. This makes it harder for the heating wire 40 to become short-circuited with the source wire 27, which is the first conductive portion, or the common electrode 28, which is the second conductive portion, than has conventionally been the case, thus making it possible to bring about improvement in yield.

Further, the first conductive portion may serve as a source wire 27 that transmits an image signal, and the heating wire 40 may extend in parallel with the source wire 27 and may be disposed to overlap the source wire 27 via the first planarizing film 34. Since the heating wire 40 and the source wire 27 run parallel to and overlap each other, improvement in aperture ratio can be brought about. Since the first planarizing film 34, which is greater in film thickness than the first interlayer insulating film 33, is sandwiched between the heating wire 40 and the source wire 27, it is hard for the heating wire 40 and the source wire 27, which run parallel to and overlap each other, to become short-circuited with each other.

The liquid crystal panel 11 may further include a second interlayer insulating film (fourth insulating film) 36 placed on top of the first transparent electrode film, a pixel electrode 25 that is composed of part of a second transparent electrode film (fourth conducting film) placed on top of the second interlayer insulating film 36 and that is disposed to overlap part of the common electrode 28, which is the second conductive portion, in the display area AA, a source electrode 24B joined to the source wire 27, a drain electrode 24C composed of a portion of the third metal film that is different from the source wire 27 and the source electrode 24B, a semiconductor component 24D that is composed of part of a semiconductor film placed at a lower layer than the first interlayer insulating film 33 and that is disposed to overlap the source electrode 24B and the drain electrode 24C, a first intermediate electrode (first connected portion) 38 composed of a portion of the fourth metal film that is different from the heating wire 40 and disposed to overlap the drain electrode 24C, and a second intermediate electrode (second connected portion) 39 composed of a portion of the first transparent electrode film that is different from the common electrode 28, which is the second conductive portion, and disposed to overlap both the first intermediate electrode 38 and the pixel electrode 25. The second conductive portion serves as a common electrode 28 that generates an electric field with the pixel electrode 25. At least the first interlayer insulating film 33 is provided with a source contact hole (first contact hole) CHS placed in such a position as to overlap both the source electrode 24B and semiconductor component 24D and a drain contact hole (second contact hole) CHD placed in such a position as to overlap the drain electrode 24C and the semiconductor component 24D. The first planarizing film 34 is provided with a first pixel contact hole (third contact hole) CHP1 placed in such a position as to overlap both the drain electrode 24C and the first intermediate electrode 38. The second planarizing film 35 is provided with a second pixel contact hole (fourth contact hole) CHP2 placed in such a position as to overlap both the first intermediate electrode 38 and the second intermediate electrode 39. The second interlayer insulating film 36 is provided with a third pixel contact hole (fifth contact hole) CHP3 placed in such a position as to overlap both the second intermediate electrode 39 and the pixel electrode 25. When a channel region is formed in the semiconductor component 24D, an image signal that is supplied from the source wire 27 to the source electrode 24B is transmitted to the drain electrode 24C via the channel region. Since the pixel electrode 25 is connected to the drain electrode 24C via the first intermediate electrode 38 and the second intermediate electrode 39, the pixel electrode 25 is charged to a potential pertaining to the image signal transmitted to the drain electrode 24C. An electric field based on a potential difference between the pixel electrode 25 and the common electrode 28 is generated between the pixel electrode 25 and the common electrode 28. In manufacturing the liquid crystal panel 11, the heating wire 40 can be provided in a step of providing the first intermediate electrode 38 by patterning the fourth metal film, as the heating wire 40 and the first intermediate electrode 38 are composed of parts of the fourth metal film. This makes it possible to reduce manufacturing cost.

Further, the liquid crystal panel 11 may further include a power supply IC (feeder) 16A that feeds electricity to the heating wire 40. The first planarizing film 34 and the second planarizing film 35 are each made from an organic material, and the power supply IC 16A has a power density of lower than or equal to 1000 W/mm³ of electric power that is supplied to the heating wire 40. The feeding of electricity to the heating wire 40 by the power supply IC 16A causes the heating wire 40 to generate heat. Since the power supply IC 16A has a power density of lower than or equal to 1000 W/mm³ of electric power that is supplied to the heating wire 40, the amount of heat generated from the heating wire 40 can be reduced. This makes it hard for the first planarizing film 34 and the second planarizing film 35, both of which are made from an organic material, to deteriorate due to excessive heating.

Further, the liquid crystal panel 11 may further include a power supply IC 16A that feeds electricity to the heating wire 40. The first planarizing film 34 and the second planarizing film 35 are each made from an organic material, and the power supply IC 16A has a power density of lower than or equal to 100 W/mm³ of electric power that is supplied to the heating wire 40. The feeding of electricity to the heating wire 40 by the power supply IC 16A causes the heating wire 40 to generate heat. Since the power supply IC 16A has a power density of lower than or equal to 100 W/mm³ of electric power that is supplied to the heating wire 40, the amount of heat generated from the heating wire 40 can be reduced. This makes it hard for the first planarizing film 34 and the second planarizing film 35, both of which are made from an organic material, to deteriorate due to excessive heating.

Further, the first interlayer insulating film 33 is made from an inorganic material, and the first planarizing film 34 and the second planarizing film 35 are made from an organic material. The first planarizing film 34 and the second planarizing film 35, which are made from an organic material, can be easily made greater in film thickness than the first interlayer insulating film 33, which is made from an inorganic material.

Further, the liquid crystal panel 11 may further include a counter substrate (second substrate) 20 placed opposite the array substrate 21 at a distance from the array substrate 20 and a liquid crystal layer 22 sandwiched between the array substrate 21 and the counter substrate 20. The liquid crystal layer 22, which is sandwiched between the array substrate 21 and the counter substrate 20 improves in response speed by being heated by the heating wire 40. The improvement in the response speed of the liquid crystal layer 22 can bring about improvement in display quality.

### Embodiment 2

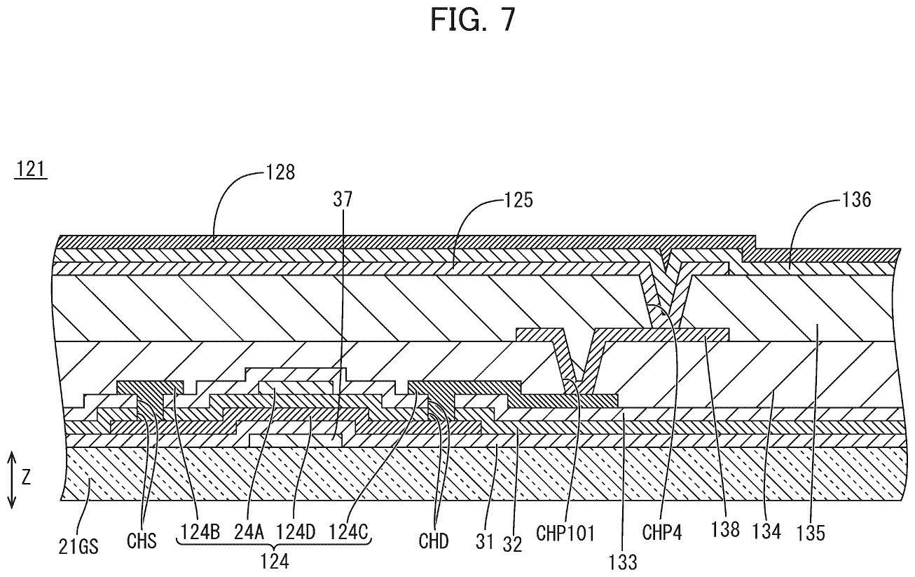

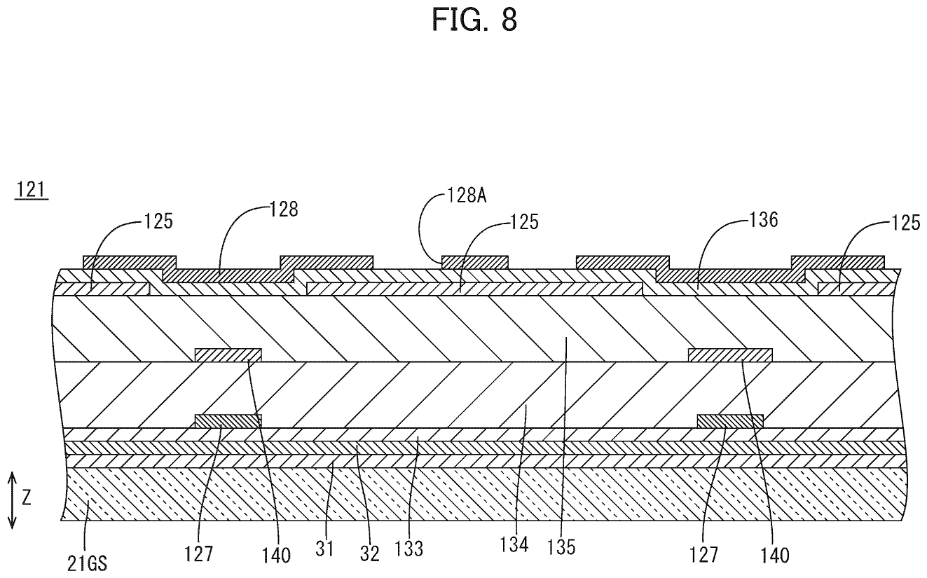

Embodiment 2 is described with reference to FIG. 7 or 8. Embodiment 2 illustrates a case where the positional relationship between a pixel electrode 125 and a common electrode 128 is reversed. A repeated description of structures, workings, and effects which are similar to those of Embodiment 1 is omitted.

In the array substrate 121 according to the present embodiment, as shown in FIGS. 7 and 8, the pixel electrode (second conductive portion) 125 is composed of part of the first transparent electrode film, and the common electrode 128 is composed of part of a second transparent electrode film. The common electrode 128 has a plurality of slits 128A bored in portions of the common electrode 128 that overlap the pixel electrode 125. Due to such a configuration, the TFT 124 includes a first intermediate electrode 138 located in between the drain electrode 124C, which is composed of part of the third metal film, and the pixel electrode 125, which is composed of part of the first transparent electrode film, but does not have the second intermediate electrode 39 (see FIG. 4) described in Embodiment 1. The first intermediate electrode 138, which is composed of part of the fourth metal film, is connected to the drain electrode 124C, which is composed of part of the third metal film, through a first pixel contact hole CHP101 provided in the first planarizing film 134. Part of the pixel electrode 125 is disposed at a higher layer than part of the first intermediate electrode 138 (i.e. a portion of the first intermediate electrode 138 that does not overlap the drain electrode 124C) to overlap the part of the first intermediate electrode 138 via the second planarizing film 135. The second planarizing film 135 has a fourth pixel contact hole (sixth contact hole) CHP4 bored in a portion of the second planarizing film 135 that overlaps both the first intermediate electrode 138 and the pixel electrode 125. The pixel electrode 125, which is composed of part of the first transparent electrode film, is connected to the first intermediate electrode 138, which is composed of the fourth metal film, through the fourth pixel contact hole CHP4 of the second planarizing film 135.

As described above, the liquid crystal panel 11 according to the present embodiment may further include a second interlayer insulating film 136 placed on top of the first transparent electrode film, a common electrode 128 that is composed of part of a second transparent electrode film placed on top of the second interlayer insulating film 136 and that is disposed to overlap the second conductive portion in the display area AA, a source electrode 124B joined to the source wire 127, a drain electrode 124C composed of a portion of the third metal film that is different from the source wire 127 and the source electrode 124B, a semiconductor component 124D that is composed of part of a semiconductor film placed at a lower layer than the first interlayer insulating film 133 and that is disposed to overlap the source electrode 124B and the drain electrode 124C, and a first intermediate electrode 138 composed of a portion of the fourth metal film that is different from the heating wire 140 and disposed to overlap the drain electrode 124C. The second conductive portion serves as a pixel electrode 125 that generates an electric field with the common electrode 128. At least the first interlayer insulating film 133 is provided with a source contact hole CHS placed in such a position as to overlap both the source electrode 124B and semiconductor component 124D and a drain contact hole CHD placed in such a position as to overlap the drain electrode 124C and the semiconductor component 124D. The first planarizing film 134 is provided with a first pixel contact hole CHP101 placed in such a position as to overlap both the drain electrode 124C and the first intermediate electrode 138. The second planarizing film 135 is provided with a fourth pixel contact hole (sixth contact hole) CHP4 placed in such a position as to overlap both the first intermediate electrode 138 and the pixel electrode 125. When a channel region is formed in the semiconductor component 124D, an image signal that is supplied from the source wire 127 to the source electrode 124B is transmitted to the drain electrode 124C via the channel region. Since the pixel electrode 125 is connected to the drain electrode 124C via the first intermediate electrode 138, the pixel electrode 125 is charged to a potential pertaining to the image signal transmitted to the drain electrode 124C. An electric field based on a potential difference between the pixel electrode 125 and the common electrode 128 is generated between the pixel electrode 125 and the common electrode 128. In manufacturing the liquid crystal panel 11, the heating wire 140 can be provided in a step of providing the first intermediate electrode 138 by patterning the fourth metal film, as the heating wire 140 and the first intermediate electrode 138 are composed of parts of the fourth metal film.

### Other Embodiments

The present disclosure is not limited to the embodiments described with reference to the foregoing description and drawings. For example, embodiments such as those listed below are encompassed in the technical scope.

The heating wires 40 and 140 may extend along the X-axis direction. In that case, the heating wires 40 and 140 intersect the source wires 27 and 127 and overlap parts of the source wires 27 and 127, respectively.
(2) The first conductive portion, at least part of which overlaps the heating wires 40 and 140, may be the gate wire 26, a capacitance wire, or other components instead of being the source wire 27 or 127. Since the gate wire 26 and the capacitance wire intersect the heating wires 40 and 140 and the source wires 27 and 127, parts of the gate wire 26 and the capacitance wire overlap parts of the heating wires 40 and 140.
(3) The power density of electric power that is supplied from the power supply IC 16A to the heating wires 40 and 140 may be higher than 1000 W/mm³.
(4) The negative electrode of the power supply IC 16A of the control substrate 16 may be connected to the first heating terminal area 43 via the flexible substrate 14, and the positive electrode of the power supply IC 16A of the control substrate 16 may be connected to the second heating terminal area 44 via the flexible substrate 14.
(5) The TFTs 24 and 124 may have a bottom-gate structure, i.e. a structure in which the gate electrode 24A is disposed at a lower layer than the semiconductor component to overlap the semiconductor component.
(6) It is also possible to omit the light shield 37. In that case, the first metal film may be removed, which gives three metal films.
(7) The driver 15 may be mounted on the first end portion 21A of each of the array substrates 21 and 121 by COG (Chip on Glass). In that case, the touch terminal area 45 and a display terminal area may be placed in such positions as to overlap the driver 15 and connected to terminal areas of the driver 15 via an anisotropic conductive film.
(8) It is also possible to omit the circuit unit 12. In that case, gate drivers having functions similar to those of the circuit unit 12 may be attached to the array substrates 21 and 121. Further, it is also possible to provide the circuit unit 12 on only one side of each of the array substrates 21 and 121.
(9) The semiconductor components 24D and 124D may be constituted by semiconductor films made of a material such as amorphous silicon or an oxide semiconductor material.
(10) The planar shape of the liquid crystal panel 11 may be a vertically long rectangle, a regular square, a circle, a semicircle, an oval, an ellipse, a trapezoid, or other shapes.
(11) The display mode of the liquid crystal panel 11 may be a VA mode, an IPS mode, or other modes other than the FFS mode.
(12) The liquid crystal panel 11 may be of a reflective type or a semi-transmissive type instead of being of a transmissive type. In a case where the liquid crystal panel 11 is of a reflective type, the backlight device can be omitted.
(13) The liquid crystal panel 11 may be replaced by another display panel (such as an organic EL display panel).

The present disclosure contains subject matter related to that disclosed in Japanese Priority Patent Application JP 2024-195108 filed in the Japan Patent Office on Nov. 7, 2024, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display device comprising:
a first substrate having a display area where an image is displayed;
a first insulating film placed on top of the first substrate;
a first conductive portion that is composed of part of a first conducting film placed on top of the first insulating film and that is placed in the display area;
a second insulating film placed on top of the first conducting film;
a heating wire that is composed of a second conducting film placed on top of the second insulating film and that overlaps at least part of the first conductive portion in the display area;
a third insulating film placed on top of the second conducting film; and
a second conductive portion that is composed of part of a third conducting film placed on top of the third insulating film and that overlaps at least part of the heating wire in the display area,
wherein the second insulating film and the third insulating film are greater in film thickness than the first insulating film.

2. The display device according to claim 1, wherein
the first conductive portion serves as a source wire that transmits an image signal, and
the heating wire extends in parallel with the source wire and is disposed to overlap the source wire via the second insulating film.

3. The display device according to claim 2, further comprising:
a fourth insulating film placed on top of the third conducting film;
a pixel electrode that is composed of part of a fourth conducting film placed on top of the fourth insulating film and that is disposed to overlap part of the second conductive portion in the display area;
a source electrode joined to the source wire;
a drain electrode composed of a portion of the first conducting film that is different from the source wire and the source electrode;
a semiconductor component that is composed of part of a semiconductor film placed at a lower layer than the first insulating film and that is disposed to overlap the source electrode and the drain electrode;
a first connected portion composed of a portion of the second conducting film that is different from the heating wire and disposed to overlap the drain electrode; and
a second connected portion composed of a portion of the third conducting film that is different from the second conductive portion and disposed to overlap both the first connected portion and the pixel electrode,
wherein
the second conductive portion serves as a common electrode that generates an electric field with the pixel electrode,
the first insulating film is provided with a first contact hole placed in such a position as to overlap both the source electrode and semiconductor component and a second contact hole placed in such a position as to overlap the drain electrode and the semiconductor component,
the second insulating film is provided with a third contact hole placed in such a position as to overlap both the drain electrode and the first connected portion,
the third insulating film is provided with a fourth contact hole placed in such a position as to overlap both the first connected portion and the second connected portion, and
the fourth insulating film is provided with a fifth contact hole placed in such a position as to overlap both the second connected portion and the pixel electrode.

4. The display device according to claim 2, further comprising:
a fourth insulating film placed on top of the third conducting film;
a common electrode that is composed of part of a fourth conducting film placed on top of the fourth insulating film and that is disposed to overlap the second conductive portion in the display area;
a source electrode joined to the source wire;
a drain electrode composed of a portion of the first conducting film that is different from the source wire and the source electrode;
a semiconductor component that is composed of part of a semiconductor film placed at a lower layer than the first insulating film and that is disposed to overlap the source electrode and the drain electrode; and
a first connected portion composed of a portion of the second conducting film that is different from the heating wire and disposed to overlap the drain electrode,
wherein
the second conductive portion serves as a pixel electrode that generates an electric field with the common electrode,
the first insulating film is provided with a first contact hole placed in such a position as to overlap both the source electrode and semiconductor component and a second contact hole placed in such a position as to overlap the drain electrode and the semiconductor component,
the second insulating film is provided with a third contact hole placed in such a position as to overlap both the drain electrode and the first connected portion, and
the third insulating film is provided with a sixth contact hole placed in such a position as to overlap both the first connected portion and the pixel electrode.

5. The display device according to claim 1, further comprising a feeder that feeds electricity to the heating wire,
wherein
the second insulating film and the third insulating film are each made from an organic material, and
the feeder has a power density of lower than or equal to 1000 W/mm³ of electric power that is supplied to the heating wire.

6. The display device according to claim 1, further comprising a feeder that feeds electricity to the heating wire,
wherein
the second insulating film and the third insulating film are each made from an organic material, and
the feeder has a power density of lower than or equal to 100 W/mm³ of electric power that is supplied to the heating wire.

7. The display device according to claim 1, wherein
the first insulating film is made from an inorganic material, and
the second insulating film and the third insulating film are made from an organic material.

8. The display device according to claim 1, further comprising:
a second substrate placed opposite the first substrate at a distance from the first substrate; and
a liquid crystal layer sandwiched between the first substrate and the second substrate.
